(19) United States
(12) Patent Application Publication
(10) Pub. No.: US 2025/0145778 A1
(43) Pub. Date: May 8, 2025

(54) RESIN FILM, METHOD FOR PRODUCING RESIN FILM, METHOD FOR USING RESIN FILM, AND METHOD FOR IMPARTING ANTIMICROBIAL ACTIVITY

(71) Applicant: Live Long Inc., Fukuoka City, Fukuoka (JP)

(72) Inventor: Soichiro SAITA, Fukuoka City (JP)

(21) Appl. No.: 18/837,518

(22) PCT Filed: Feb. 15, 2023
(86) PCT No.: PCT/JP2023/005206

§ 371 Date: Aug. 9, 2024

(30) Foreign Application Priority Data
Feb. 15, 2022 (JP) 2022-021144

(51) Int. Cl. C08J 5/18; B32B 27/18; B32B 27/34

(52) U.S. Cl. CPC C08J 5/18; B32B 27/18; B32B 27/34; B32B 2250/02; B32B 2307/726; B32B 2307/728; B32B 2307/732; B32B 2377/00; B32B 2439/70; C08J 2377/02

(57) ABSTRACT

There is provided a resin film including a resin layer having chemical permeability, and a chemical layer, in which at least one chemical selected from the group consisting of a carboxylic acid having 1 to 36 carbon atoms, a carboxylic acid ester having 2 to 36 carbon atoms, a sulfonic acid ester having 1 to 36 carbon atoms, a siloxane compound having 1 to 36 carbon atoms, a benzophenone compound having 13 to 38 carbon atoms, a phosphoric acid ester having 1 to 80 carbon atoms, and a phosphorous acid ester having 1 to 80 carbon atoms permeates the resin layer and the chemical is present on a first surface of the resin layer, and the chemical layer containing the chemical is provided on a second surface of the resin layer.

### TECHNICAL FIELD

The present invention relates to a resin film, a method for producing a resin film, a method for using a resin film, and a method for imparting antimicrobial activity. Priority is claimed on Japanese Patent Application No. 2022-021144, filed Feb. 15, 2022, the content of which is incorporated herein by reference.

### BACKGROUND ART

A resin film having antimicrobial activity such as antibacterial activity is used, for example, for a food packaging film or the like.

In recent years, food waste has become a significant social problem. It is expected that food waste can be reduced in a case where the shelf life of the food can be extended by using a food packaging film having antimicrobial activity.

As the resin film having antimicrobial activity, a laminated structure resin film in which an antibacterial layer is formed on one surface of a base material layer is known (Patent Document 1 and Patent Document 2). Such a resin film is usually obtained by coating one surface of the base material layer with a solution containing a chemical having antibacterial effect and drying the solution to form an antibacterial layer on one surface of the base material. In the resin film obtained in this manner, the surface on the antibacterial layer side is the surface of the resin film, and the surface on the base material layer side is the back surface of the resin film, and the surface of the resin film has antimicrobial activity.

On the other hand, to sustainedly release the volatile flavoring agent, a film that consists of a chemical-containing film encapsulating a volatile chemical and a sustained-release layer that suppresses gas permeation by adding a filler to the sustained-release layer has been proposed (Patent Document 3).

### CITATION LIST

### Patent Documents

### [Patent Document 1]

Published Japanese Translation No. 2008-545761 of the PCT International Publication

### [Patent Document 2]

United States Patent Application, Publication No. 2005/0129937

### [Patent Document 3]

Japanese Unexamined Patent Application, First Publication No. 2019-069581

### SUMMARY OF INVENTION

### Technical Problem

However, in a case of the resin films described in Patent Document 1 and Patent Document 2, the concentration of the chemical in the antibacterial layer is determined in a stage of producing the resin film, that is, in a stage of applying a solution containing the chemical onto one surface of the base material layer. Therefore, in a case where the concentration of the chemical in the antibacterial layer is low, an antibacterial effect cannot be maintained for a long period of time. To maintain the antibacterial effect, it is sufficient to increase the concentration of the chemical in the antibacterial layer. However, since the antibacterial layer is easily touched by a human hand or the like, the antibacterial layer may cause strong irritation to the skin depending on the type of the chemical. In this way, it has been difficult to adjust the concentration of the chemical on the surface of the resin film.

In addition, the film described in Patent Document 3 is for the purpose of sustainedly releasing the synthetic flavoring agent, and has not been studied as a resin film having antimicrobial activity.

An object of the present invention is to provide a resin film in which a concentration of a chemical on a surface can be easily adjusted, a method for producing a resin film, a method for using a resin film, and a method for imparting antimicrobial activity.

### Solution to Problem

The present invention has the following aspects.
[1] A resin film including a resin layer having chemical permeability, and a chemical layer, in which at least one chemical selected from the group consisting of a carboxylic acid having 1 to 36 carbon atoms, a carboxylic acid ester having 2 to 36 carbon atoms, a sulfonic acid ester having 1 to 36 carbon atoms, a siloxane compound having 1 to 36 carbon atoms, a benzophenone compound having 13 to 38 carbon atoms, a phosphoric acid ester having 1 to 80 carbon atoms, and a phosphorous acid ester having 1 to 80 carbon atoms permeates the resin layer and the chemical is present on a first surface of the resin layer, and the chemical layer containing the chemical is provided on a second surface of the resin layer.
[2] The resin film according to [1], in which the chemical is at least one selected from the group consisting of a carboxylic acid having 1 to 30 carbon atoms, a carboxylic acid ester having 2 to 30 carbon atoms, a sulfonic acid ester having 1 to 18 carbon atoms, a siloxane compound having 1 to 18 carbon atoms, a benzophenone compound having 13 to 20 carbon atoms, a phosphoric acid ester having 1 to 40 carbon atoms, and a phosphorous acid ester having 1 to 40 carbon atoms.
[3] The resin film according to [1] or [2], in which the resin layer is hydrophilic.
[4] The resin film according to any one of [1] to [3], in which the resin layer contains at least one resin selected from the group consisting of polyamide, a cellulose resin, and polyurethane.
[5] The resin film according to [4], in which the resin layer contains polyamide, and the polyamide includes either or both of nylon 6 and nylon 66.
[6] The resin film according to any one of [1] to [5], in which the resin layer has a film thickness of 20 μm or more.
[7] Use of the resin film according to any one of [1] to [6] as a building material.
[8] A method for producing a resin film which is a method for producing the resin film according to any one of [1] to [6], the method including bringing the chemical or a composition containing the chemical into contact with the second surface of the resin layer for 5 seconds or more and allowing at least a part of the chemical to permeate to the first surface of the resin layer, to impart antimicrobial activity to the first surface of the resin layer.
[9] A method for using a resin film which is a method for using the resin film according to any one of [1] to [6], the method including providing the resin film at a portion where activity of a microorganism is to be reduced, such that the first surface of the resin layer is brought into contact with the microorganism.
[10] A method for imparting antimicrobial activity, including bringing a chemical that is at least one selected from the group consisting of a carboxylic acid having 1 to 36 carbon atoms, a carboxylic acid ester having 2 to 36 carbon atoms, a sulfonic acid ester having 1 to 36 carbon atoms, a siloxane compound having 1 to 36 carbon atoms, a benzophenone compound having 13 to 38 carbon atoms, and a phosphoric acid ester having 1 to 80 carbon atoms, or a composition containing the chemical, into contact with a second surface of a resin film having chemical permeability, and allowing at least a part of the chemical to permeate to a first surface of a resin layer, to impart antimicrobial activity to the first surface of the resin layer.

### Advantageous Effects of Invention

According to the present invention, a resin film in which a concentration of a chemical on a surface can be easily adjusted, a method for producing a resin film, a method for using a resin film, and a method for imparting antimicrobial activity can be provided.

### BRIEF DESCRIPTION OF DRAWINGS

FIG. 1 is a cross-sectional view schematically showing an example of a resin film according to the embodiment of the present invention.

FIG. 2 is a cross-sectional view schematically showing an example of a method for producing a resin film according to the embodiment of the present invention.

FIG. 3 is a graph showing analysis results of TOF-SIMS of a test piece obtained in Example 1 and a comparative test piece obtained in Comparative Example 1.

FIG. 4 is a graph showing analysis results of TOF-SIMS of the test piece obtained in Example 1 and the comparative test piece obtained in Comparative Example 1.

FIG. 5 is a graph showing results of an antibacterial test of a test piece obtained in Example 2 and the comparative test piece obtained in Comparative Example 1.

FIG. 6 is a graph showing results of an antibacterial test of test pieces obtained in Example 3 and Example 4, and the comparative test piece obtained in Comparative Example 1.

FIG. 7 is a graph showing results of an antiviral test of the test piece obtained in Example 1 and the comparative test piece obtained in Comparative Example 1.

FIG. 8 is a graph showing results of an antiviral test of a test piece obtained in Example 5 and the comparative test piece obtained in Comparative Example 1.

### DESCRIPTION OF EMBODIMENTS

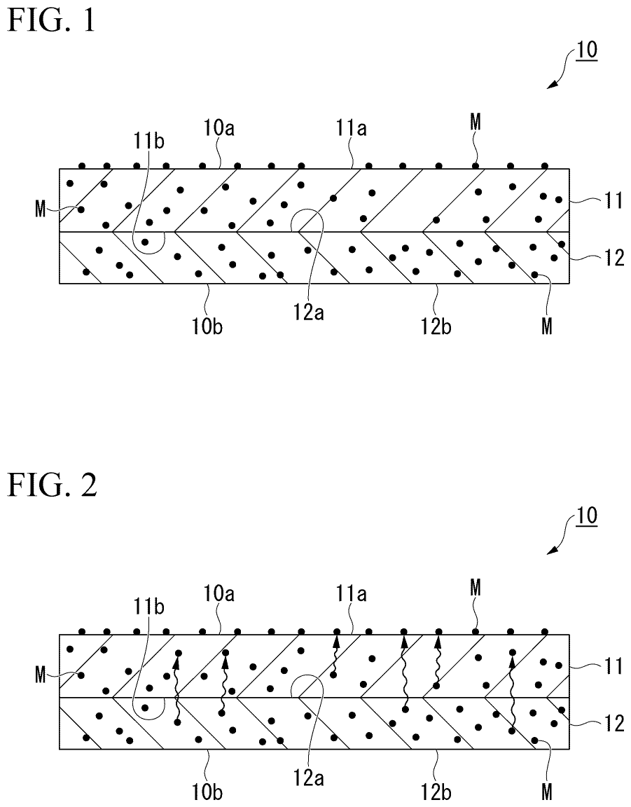

Hereinafter, an embodiment such as a resin film according to the present invention will be described in detail with reference to FIG. 1 as appropriate.

The numerical range represented by using “to” includes the numerical values at both ends of “to”.

In addition, in the drawings used in the following description, the featured portions may be enlarged and shown to make the features of the present invention easy to understand, and a dimension ratio and the like of each component may be different from the actual state.

### Resin Film

FIG. 1 is a cross-sectional view schematically showing an example of a resin film according to a first aspect of the present invention.

The resin film 10 shown in FIG. 1 includes a resin layer 11 and a chemical layer 12 provided on a second surface 11b of the resin layer 11 and containing a chemical M, in which the chemical M permeates the resin layer 11 and the chemical M is present on a first surface 11a of the resin layer 11.

In the present invention, the first surface 11a of the resin layer 11 is a front surface 10a of the resin film 10. The front surface 10a of the resin film 10 is a surface being brought into contact with the microorganism.

In addition, in the present invention, a surface of the resin film 10 opposite to the front surface 10a is referred to as a back surface 10b of the resin film 10. In the case of the resin film 10 shown in FIG. 1, a second surface 12b, which is a surface of the chemical layer 12 opposite to the resin layer 11, is a back surface 10b of the resin film 10.

In addition, in the present invention, the first surface 11a of the resin layer 11 is also referred to as a front surface of the resin layer 11, and the second surface 11b of the resin layer 11 is also referred to as a back surface of the resin layer 11.

In addition, in the present invention, a first surface 12a, which is a surface of the chemical layer 12 on a resin layer 11 side, is also referred to as a front surface of the chemical layer 12, and a second surface 12b of the chemical layer 12 is also referred to as a back surface of the chemical layer 12.

### Chemical

The chemical M imparts antimicrobial activity to the first surface 11a of the resin layer 11, that is, the front surface 10a of the resin film 10.

The chemical M is at least one selected from the group consisting of a carboxylic acid having 1 to 36 carbon atoms, a carboxylic acid ester having 2 to 36 carbon atoms, a sulfonic acid ester having 1 to 36 carbon atoms, a siloxane compound having 1 to 36 carbon atoms, a benzophenone compound having 13 to 38 carbon atoms, a phosphoric acid ester having 1 to 80 carbon atoms, and a phosphorous acid ester having 1 to 80 carbon atoms.

In FIG. 1, the chemical M is only shown in a schematic manner, and the chemical M is not always present in a particulate form.

### Carboxylic Acid Having 1 to 36 Carbon Atoms

Examples of the carboxylic acid having 1 to 36 carbon atoms include short-chain fatty acids (fatty acids having less than 6 carbon atoms) such as formic acid (CH₂O₂), acetic acid (C₂H₄O₂), propionic acid (C₃H₆O₂), butyric acid (C₄H₈O₂), isobutyric acid (C₄H₈O₂), valeric acid (C₅H₁₀O₂); medium-chain fatty acids (fatty acids having 6 to 12 carbon atoms) such as caproic acid (C₆H₁₂O₂), enanthic acid (C₇H₁₄O₂), caprylic acid (C₈H₁₆O₂), capric acid (C₁₀H₂₀O₂), lauric acid (C₁₂H₂₄O₂); long-chain fatty acids (fatty acids having 13 to 21 carbon atoms) such as myristic acid (C₁₄H₂₈O₂), palmitic acid (C₁₆H₃₂O₂), stearic acid (C₁₈H₃₆O₂); and ultra-long-chain fatty acids (fatty acids having 22 to 36 carbon atoms) such as behenic acid (C₂₂H₄₄O₂).

As the carboxylic acid having 1 to 36 carbon atoms, it is preferable to use at least one selected from the group consisting of these exemplified carboxylic acids having 1 to 36 carbon atoms.

The carboxylic acid having 1 to 36 carbon atoms may be used alone or a combination of two or more types thereof may be used.

As the carboxylic acid having 1 to 36 carbon atoms, a carboxylic acid having 1 to 30 carbon atoms is preferable, and a carboxylic acid having 2 to 20 carbon atoms is more preferable. These carboxylic acids may be used alone or a combination of two or more types thereof may be used.

### Carboxylic Acid Ester Having 2 to 36 Carbon Atoms

Examples of the carboxylic acid ester having 2 to 36 carbon atoms include formic acid esters such as methyl formate (C₂H₄O₂) and ethyl formate (C₃H₆O₂); acetic acid esters such as methyl acetate (C₃H₆O₂), ethyl acetate (C₄H₈O₂), vinyl acetate (C₄H₆O₂), propyl acetate (C₅H₁₀O₂), butyl acetate (C₆H₁₂O₂), . . . , pentyl acetate (C₇H₁₄O₂), hexyl acetate (C₈H₁₆O₂), heptyl acetate (C₉H₁₉O₂), and octyl acetate (C₁₀H₂₀O₂); and propionic acid esters such as methyl propionate (C₄H₈O₂), ethyl propionate (C₅H₁₀O₂), and vinyl propionate (C₅H₈O₂). As the carboxylic acid ester having 2 to 36 carbon atoms, it is preferable to use at least one selected from the group consisting of these exemplified carboxylic acid esters having 2 to 36 carbon atoms.

The carboxylic acid ester having 2 to 36 carbon atoms may be used alone or a combination of two or more types thereof may be used.

As the carboxylic acid ester having 2 to 36 carbon atoms, a carboxylic acid ester having 2 to 30 carbon atoms is preferable, a carboxylic acid ester having 2 to 20 carbon atoms is more preferable, and a carboxylic acid ester having 3 to 8 carbon atoms is still more preferable. These carboxylic acid esters may be used alone or a combination of two or more types thereof may be used.

Among these, the carboxylic acid ester having 2 to 36 carbon atoms is even still more preferably an acetic acid ester, and the acetic acid ester is preferably an acetic acid ester having 3 to 8 carbon atoms.

The acetic acid ester having 3 to 8 carbon atoms may be used alone or a combination of two or more types thereof may be used.

### Sulfonic Acid Ester Having 1 to 36 Carbon Atoms

Examples of the sulfonic acid ester having 1 to 36 carbon atoms include alkylbenzenesulfonic acids such as methylbenzenesulfonic acid (toluenesulfonic acid) (C₇H₈O₃S), ethylbenzenesulfonic acid (C₈H₁₀O₃S), propylbenzenesulfonic acid (C₉H₁₂O₃S), butylbenzenesulfonic acid (C₁₀H₁₄O₃S), pentylbenzenesulfonic acid (C₁₁H₁₆O₃S), hexylbenzenesulfonic acid (C₁₂H₁₈O₃S), heptylbenzenesulfonic acid (C₁₃H₂₀O₃S), octylbenzenesulfonic acid (C₁₄H₂₂O₃S), nonylbenzenesulfonic acid (C₁₅H₂₄O₃S), and decylbenzenesulfonic acid (C₁₆H₂₆O₃S); and alkanesulfonic acids such as methanesulfonic acid (CH₄O₃S), ethanesulfonic acid (C₂H₆O₃S), propanesulfonic acid (C₃H₈O₃S), and butanesulfonic acid (C₄H₁₀O₃S). As the sulfonic acid ester having 1 to 36 carbon atoms, it is preferable to use at least one selected from the group consisting of sulfonic acid esters having 1 to 36 carbon atoms.

The sulfonic acid ester having 1 to 36 carbon atoms may be used alone or a combination of two or more types thereof may be used.

As the sulfonic acid ester having 1 to 36 carbon atoms, a sulfonic acid ester having 1 to 18 carbon atoms is preferable, a sulfonic acid ester having 1 to 10 carbon atoms is more preferable, and a sulfonic acid ester having 6 to 10 carbon atoms is still more preferable.

Among these, the sulfonic acid ester having 1 to 36 carbon atoms is even still more preferably an alkylbenzenesulfonic acid ester is more preferable, and the alkylbenzenesulfonic acid ester is preferably an alkylbenzenesulfonic acid ester having an alkyl group having 6 to 10 carbon atoms.

The alkylbenzenesulfonic acid having an alkyl group having 6 to 10 carbon atoms may be used alone or a combination of two or more types thereof may be used.

### Siloxane Compound Having 1 to 36 Carbon Atoms

Examples of the siloxane compound having 1 to 36 carbon atoms include 3-glycidyloxypropyltrimethoxysilane (C₉H₂₀O₅Si), 3-glycidyloxypropyl(dimethoxy)methylsilane (C₉H₂₀O₄Si), diethoxy(3-glycidyloxypropyl)methylsilane (C₁₁H₂₄O₄Si), (3-(meth)acryloyloxy)propyltrimethoxysilane (C₁₀H₂₀O₅Si), 3-((meth)acryloyloxy)propylmethyldimethoxysilane (C₁₀H₂₀O₄Si), (3-mercaptopropyl)trimethoxysilane (C₆H₁₆O₃SSi), 3-mercaptopropyl(dimethoxy)methylsilane (C₆H₁₆O₂SSi), (3-mercaptopropyl)triethoxysilane (C₉H₂₂O₃SSi), 3-aminopropyltrimethoxysilane (C₆H₁₇NO₃Si), 3-aminopropyltriethoxysilane (C₉H₂₃NO₃Si), 3-(2-aminoethyl)aminopropyltrimethoxysilane (C₈H₂₂N₂O₃Si), trimethoxy[3-(phenylamino)propyl]silane (C₁₂H₂₁NO₃Si), vinyltrimethoxysilane (C₅H₁₂O₃Si), triethoxyvinylsilane (C₈H₁₈O₃Si), 3-((meth)acryloyloxy)propylmethyldiethoxysilane (C₁₂H₂₄O₄Si), 3-(meth)acryloyloxypropyltriethoxysilane (C₁₃H₂₆O₅Si), N-(2-aminoethyl)-3-aminopropylmethyldimethoxysilane (C₈H₂₂N₂O₂Si), and 3-isocyanatopropyltriethoxysilane (C₇H₁₅NO₄Si). As the siloxane compound having 1 to 36 carbon atoms, it is preferable to use at least one selected from the group consisting of siloxane compounds having 1 to 36 carbon atoms.

The siloxane compound having 1 to 36 carbon atoms may be used alone or a combination of two or more types thereof may be used.

The siloxane compound having 1 to 36 carbon atoms is preferably a siloxane compound having 1 to 18 carbon atoms, and more preferably a siloxane compound having 1 to 10 carbon atoms.

### Benzophenone Compound Having 13 to 38 Carbon Atoms

Examples of the benzophenone compound having 13 to 38 carbon atoms include benzophenone (C₁₃H₁₀O), 4-hydroxybenzophenone (C₁₃H₁₀O₂), 4-methoxybenzophenone (C₁₄H₁₂O₂), and the like. As the benzophenone compound having 13 to 38 carbon atoms, it is preferable to use at least one selected from the group consisting of benzophenone compounds having 13 to 38 carbon atoms.

The benzophenone compound having 13 to 38 carbon atoms may be used alone or a combination of two or more types thereof may be used.

As the benzophenone compound having 13 to 38 carbon atoms, a benzophenone compound having 13 to 20 carbon atoms is preferable, a benzophenone compound having 13 to 18 carbon atoms is more preferable, and a benzophenone compound having 13 to 17 carbon atoms is still more preferable.

### Phosphoric Acid Ester Having 1 to 80 Carbon Atoms

Examples of the phosphoric acid ester having 1 to 80 carbon atoms include phosphoric acid monoesters such as methyl phosphate (CH₅O₄P); phosphoric acid diesters such as diethyl phosphate (C₄H₁₁O₄P); and phosphoric acid triesters such as trimethyl phosphate (C₃H₉O₄P) and triphenyl phosphate (C₁₈H₁₅O₄P). As the phosphoric acid ester having 1 to 80 carbon atoms, it is preferable to use at least one selected from the group consisting of phosphoric acid esters having 1 to 80 carbon atoms.

The phosphoric acid ester having 1 to 80 carbon atoms may be used alone or a combination of two or more types thereof may be used.

As the phosphoric acid ester having 1 to 80 carbon atoms, a phosphoric acid ester having 1 to 40 carbon atoms is preferable, a phosphoric acid ester having 1 to 20 carbon atoms is more preferable, and a phosphoric acid ester having 1 to 10 carbon atoms is still more preferable.

### Phosphorous Acid Ester Having 1 to 80 Carbon Atoms

Examples of the phosphorous acid ester having 1 to 80 carbon atoms include triphenyl phosphite (C₁₈H₁₅O₃P), tris(4-nonylphenyl) phosphite (C₄₅H₆₉O₃P), tricresyl phosphite (C₂₁H₂₁O₃P), tristearyl phosphite (C₅₄H₁₁₁O₃P), triethyl phosphite (C₆H₁₅O₃P), tris(2-ethylhexyl) phosphite (C₂₄H₅₁O₃P), hydrogenated bisphenol A-pentaerythritol phosphite polymer, hydrogenated bisphenol A phosphite polymer, diethyl phosphite (C₄H₁₁O₃P), bis(2-ethylhexyl) phosphite (C₁₆H₃₅O₃P), dilauryl phosphite (C₂₄H₅₁O₃P), dioleyl phosphite (C₃₆H₇₁O₃P), and diphenyl phosphite (C₁₂H₁₁O₃P). As the phosphorous acid ester having 1 to 80 carbon atoms, it is preferable to use at least one selected from the group consisting of phosphorous acid esters having 1 to 80 carbon atoms.

The phosphorous acid ester having 1 to 80 carbon atoms may be used alone or a combination of two or more types thereof may be used.

As the phosphorous acid ester having 1 to 80 carbon atoms, a phosphorous acid ester having 1 to 40 carbon atoms is preferable, a phosphorous acid ester having 1 to 20 carbon atoms is more preferable, and a phosphorous acid ester having 1 to 10 carbon atoms is still more preferable.

### Preferred Aspect of Chemical M

The chemical M is preferably at least one selected from the group consisting of a carboxylic acid having 1 to 30 carbon atoms, a carboxylic acid ester having 2 to 30 carbon atoms, a sulfonic acid ester having 1 to 18 carbon atoms, a siloxane compound having 1 to 18 carbon atoms, a benzophenone compound having 13 to 20 carbon atoms, and a phosphoric acid ester having 1 to 40 carbon atoms.

The chemical M is more preferably at least one selected from the group consisting of a carboxylic acid having 2 to 20 carbon atoms, a carboxylic acid ester having 2 to 20 carbon atoms, a sulfonic acid ester having 1 to 10 carbon atoms, a siloxane compound having 1 to 10 carbon atoms, a benzophenone compound having 13to 18 carbon atoms, and a phosphoric acid ester having 1 to 20 carbon atoms. The chemical M is still more preferably at least one selected from the group consisting of an acetic acid ester having 3 to 8 carbon atoms, an alkylbenzenesulfonic acid having 6 to 10 carbon atoms, a siloxane compound having 1 to 10 carbon atoms, a benzophenone compound having 13 to 17 carbon atoms, and a phosphoric acid ester having 1 to 10 carbon atoms, and particularly more preferably includes an acetate ester having 3 to 8 carbon atoms.

### Resin Layer

The resin layer is described with reference to FIG. 1.

The resin layer 11 is a film having chemical permeability.

In the present invention, the “chemical permeability” refers to a property in which a chemical adhering to a front surface or a back surface of the resin layer 11 permeates into an inside of the resin layer 11, and the chemical that has permeated into the inside of the resin layer 11 oozes out to the front surface or the back surface of the resin layer 11.

The chemical M has permeated the resin layer 11.

The chemical M preferably permeates from the second surface 11b to the first surface 11a of the resin layer 11. In a case where the chemical M permeates from the second surface 11b to the first surface 11a of the resin layer 11, stickiness of the front surface 10a of the resin film 10 caused by the chemical M can be suppressed.

The chemical M is present on the first surface 11a of the resin layer 11. In a case where the chemical M is present on the first surface 11a of the resin layer 11, antimicrobial activity is imparted to the first surface 11a of the resin layer 11, that is, the front surface 10a of the resin film 10.

In addition, since the chemical M permeates the resin layer 11, even in a case where the chemical M present on the first surface 11a of the resin layer 11 is consumed and decreased, at least a part of the chemical M that has permeated the resin layer 11 gradually oozes out to the first surface 11a of the resin layer 11, thereby the antimicrobial activity can be maintained for a long period of time.

The antimicrobial activity is preferably at least one selected from the group consisting of antibacterial activity, antifungal activity, and antiviral activity.

The antibacterial activity is evaluated, for example, by a testing method based on JIS Z 2801:2012 (Antibacterially processed product-method for antibacterial test and antibacterial effect) or the like.

The antifungal activity is evaluated, for example, by a testing method based on JIS Z 2911:2018 (Method for fungus resistance test) or the like.

The antiviral activity is evaluated, for example, by a testing method based on ISO 21702:2019 (Measurement of antiviral activity on plastics and other non-porous surfaces) or the like.

In a case where the antibacterial activity is imparted to the first surface 11a of the resin layer 11, it is desirable that the resin film 10 has antibacterial activity against at least one selected from the group consisting of gram-negative bacteria other than Escherichia coli, for example, Salmonella, enterobacteria, Pseudomonas, Moraxella, Helicobacter, Bdellovibrio, Acetobacter, and Legionella.

In addition, it is desirable that the resin film 10 has antibacterial activity against at least one selected from the group consisting of gram-positive bacteria other than Staphylococcus aureus, for example, Firmicutes such as Bacillus, Lactobacillus, Clostridium, Thermoanaerobacter, Haloanaerobium, Natranaerobius, and Erysipelotrichus, and Actinomycetota such as Actinomyces, Streptomyces, and Bifidobacterium.

In a case where the antifungal activity is imparted to the first surface 11a of the resin layer 11, it is desirable that the resin film 10 has antifungal activity against at least one selected from the group consisting of fungi and yeasts other than Aspergillus and Cladosporium, for example, Penicillium, Trichoderma, Fusarium, Neurospora, Aureobasidium, Saccharomyces, Candida, Cryptococcus, and Schizosaccharomyces.

In a case where the antiviral activity is imparted to the first surface 11a of the resin layer 11, it is desirable that the resin film 10 has antiviral activity against at least one selected from the group consisting of viruses having an envelope, for example, a varicella-zoster virus, a smallpox virus, a hepatitis B virus, a hepatitis C virus, a Japanese encephalitis virus, a Zika virus, a rubella virus, a SARS coronavirus, a MERS coronavirus, a hepatitis D virus, a measles virus, a human RS virus, a rabies virus, a Crimean-Congo hemorrhagic fever virus, an Ebola virus, a Marburg virus, a human immunodeficiency virus, an A-type influenza virus (H1N1, H3N2, and the like), and an adult T-cell leukemia virus.

In addition, it is desirable that the resin film 10 has antiviral activity against at least one selected from the group consisting of viruses having no envelope other than Feline calicivirus (alternative to the norovirus), for example, an adenovirus, a human papillomavirus, a poliovirus, a hepatitis A virus, a norovirus, and a rotavirus.

In addition, it is desirable that the resin film 10 has antiviral activity against Novel coronavirus.

The resin constituting the resin layer 11 is not particularly limited as long as the resin has chemical permeability, and is preferably a hydrophilic resin. The hydrophilicity of the resin can be represented by, for example, a water absorption rate measured by an ASTM D570 method. From the viewpoints of the permeability of the chemical M according to the embodiment of the present invention and that the concentration of the chemical M can be easily adjusted, a resin having a water absorption rate of 0.5 or more is preferable, a resin having a water absorption rate of 0.75 or more is more preferable, and a resin having a water absorption rate of 1.0 or more is most preferable.

Specific examples thereof include polyamide, a cellulose resin, and polyurethane. Among these, from the viewpoint of particularly excellent chemical permeability and particularly excellent concentration adjustment, polyamide is preferable.

The resin layer 11 may contain only one type of the above-described resin, or may contain two or more types of the resins.

In addition, the resin layer 11 may be a single-layer film or a laminated film in which a plurality of single-layer films are laminated. In a case where the resin layer 11 is a laminated film, the resins constituting each single-layer film may be the same type or different types, but it is preferable that at least one single-layer film contains polyamide.

Examples of the polyamide include nylons such as nylon 6, nylon 11, nylon 12, nylon 66, nylon 610, nylon 6T, nylon 9T, nylon MST, nylon 612, and the like. Among these, from the viewpoint of excellent tensile strength and excellent breaking strength in a case of being formed into a film, nylon 6 or nylon 66 is preferable, and nylon 6 is more preferable.

Examples of the cellulose resin include nitrocellulose, acetyl cellulose, and the like.

Examples of the polyurethane include a polyester-based thermoplastic polyurethane, a polyether-based thermoplastic polyurethane, a polycarbonate-based thermoplastic polyurethane, and the like.

Each of the polyamide, the cellulose resin, and the polyurethane may be used alone as one type, or in combination of two or more types thereof.

A thickness of the resin layer 11 is not particularly limited, but is preferably 0.01 μm or more, more preferably 0.1 μm or more, still more preferably 20 μm or more, even still more preferably 30 μm or more, and particularly preferably 50 μm or more. In addition, the thickness of the resin layer 11 is preferably 5,000 μm or less, more preferably 2,500 μm or less, still more preferably 1,000 μm or less, even still more preferably 500 μm or less, and particularly preferably 300 μm or less. In a case where the thickness of the resin layer is the above-described lower limit value or more, the breakage of the film during use is prevented and the sustained-release period of the chemical M also tends to be maintained. In addition, in a case where the thickness of the resin layer is the above-described upper limit value or less, the flexibility of the resin film is likely to be retained and the resin film 10 can be provided at various locations such as a curved surface. In addition, the reaching of the chemical M to the surface of the resin layer is not too long, and the use tends to be facilitated.

### Chemical Layer

The chemical layer 12 is a layer containing the chemical M, and is provided on the second surface 11b of the resin layer 11.

In a case of the resin film 10 shown in FIG. 1, at least a part of the chemical M contained in the chemical layer 12 permeates from the second surface 11b to the first surface 11a of the resin layer 11, and oozes out to the first surface 11a.

The chemical layer 12 may contain components other than the chemical M (hereinafter, also referred to as “other components”).

In the other components, the resin layer preferably has compatibility and pressure-sensitive adhesiveness with the other components of the chemical layer. The other components may move to the surface of the resin layer in the same manner as the chemical M, or may remain as the chemical layer.

Examples of the other components include a (meth)acrylic polymer. Examples of the (meth)acrylic polymer include a homopolymer of alkyl (meth)acrylate; a copolymer obtained by copolymerizing alkyl (meth)acrylate and a monomer component copolymerizable with the alkyl (meth)acrylate.

From the viewpoint of imparting pressure-sensitive adhesiveness to the chemical layer 12, a copolymer obtained by copolymerizing an alkyl (meth)acrylate and at least one monomer component selected from the group consisting of a carboxyl group-containing monomer, a hydroxyl group-containing monomer, an amino group-containing monomer, an epoxy group-containing monomer, an amide group-containing monomer, and other vinyl monomers other than these monomers, which are copolymerizable with the alkyl (meth)acrylate, is preferable. That is, the copolymer includes an alkyl (meth)acrylate unit and a unit derived from a monomer component copolymerizable with the alkyl (meth)acrylate, and preferably includes an alkyl (meth)acrylate unit and a unit derived from at least one monomer component selected from the group consisting of a carboxyl group-containing monomer, a hydroxyl group-containing monomer, an amino group-containing monomer, an epoxy group-containing monomer, an amide group-containing monomer, and other vinyl monomers other than these monomers.

The other components may be used alone or a combination of two or more types thereof may be used.

A content of the chemical M in the chemical layer 12 is not particularly limited, and the content of the chemical M may be determined in a range of an amount which can be contained in the chemical layer 12 according to a portion where the resin film 10 is provided.

A thickness of the chemical layer 12 is not particularly limited, but is, for example, preferably 0.005 μm or more, more preferably 0.5 μm or more, still more preferably 5 μm or more, and particularly preferably 50 μm or more. In addition, the thickness of the chemical layer 12 is preferably 50,000 μm or less, more preferably 500 μm or less, and particularly preferably 500 μm or less. In a case where the thickness of the chemical layer 12 is the above-described lower limit value or more, the total amount of the chemicals M contained in the resin film 10 is increased, thereby the antimicrobial activity can be maintained for a longer period of time. In a case where the thickness of the chemical layer 12 is the above-described upper limit value or less, the flexibility of the resin film 10 is likely to be retained, and the resin film 10 can be provided at various locations.

Here, it is preferable that the resin layer and the chemical layer are constituted of different resins. The reason is that the roles played by the resin layer and the chemical layer are different from each other. That is, this is because it is preferable that the resin layer has the abrasion resistance and the water resistance since the resin layer is directly exposed to the external environment, but on the other hand, it is preferable that the chemical layer is constituted of the soft resin to control the concentration of the chemical M and not to prevent the movement of the chemical M.

From the above viewpoint, a particularly preferred combination is polyamide as the resin of the resin layer, and alkyl (meth)acrylate and a carboxyl group-containing monomer, an amide group-containing monomer, or the other vinyl monomer other than these monomers, which is copolymerizable with the alkyl (meth)acrylate, as the other components of the chemical layer.

### Production Method

The resin film 10 is obtained, for example, by bringing the chemical M or a composition containing the chemical M (hereinafter, also referred to as “composition (C)”) into contact with the second surface 11b of the resin layer 11 and allowing at least a part of the chemical M to permeate to the first surface 11a of the resin layer 11, to impart antimicrobial activity to the first surface 11a of the resin layer 11.

Since the resin layer 11 has chemical permeability, for example, as shown in FIG. 2, the chemical M adhering to the back surface of the resin layer 11 (that is, the second surface 11b) permeates into the inside of the resin layer 11, and the chemical M that has permeated into the inside of the resin layer 11 oozes out to the front surface of the resin layer 11 (that is, the first surface 11a). Therefore, even in a case where the chemical M or the composition (C) is not applied to the resin layer 11 from the front surface side, the chemical M is present on the first surface 11a of the resin layer 11 and the antimicrobial activity can be exhibited.

The composition (C) contains the chemical M.

The composition (C) may contain a component from which the chemical M is derived, instead of the chemical M. The component from which the chemical M is derived is a component which generates the chemical M by decomposition or the like.

The composition (C) may contain other components. Examples of the other components include the other components provided as exemplary examples in the description of the chemical layer 12. The other components may be used alone or a combination of two or more types thereof may be used.

In addition, the composition (C) may contain a solvent other than the chemical M. Examples of the solvent include water; organic solvents such as methanol, ethanol, isopropyl alcohol, hexane, heptane, toluene, and xylene; and the like. The solvent may be used alone or a combination of two or more types thereof may be used.

A method of bringing the chemical M or the composition (C) into contact with the second surface 11b of the resin layer 11 is not particularly limited, and examples thereof include a method (1) of bringing the chemical M into contact with the second surface 11b of the resin layer 11 by bonding a film (hereinafter, also referred to as “film (F)”) containing the chemical M or a component derived from the chemical M to the second surface 11b of the resin layer 11; a method (2) of bringing the chemical M or the composition (C) into contact with the second surface 11b of the resin layer 11 by spray coating, roller coating, or the like; a method (3) of bringing the chemical M or the composition (C) into contact with the second surface 11b of the resin layer 11 by immersing the second surface 11b of the resin layer 11 in the chemical M or the composition (C); and the like.

As the film (F), a commercially available product can be used.

A contact time in a case where the chemical M or the composition (C) is brought into contact with the second surface 11b of the resin layer 11 is preferably 5 seconds or more, more preferably 10 seconds or more, still more preferably 1 minute or more, and particularly preferably 5 minutes or more. The contact time may be 20 minutes or more, but usually, a sufficient antimicrobial activity is obtained by a contact for 20 minutes.

A contact temperature in a case where the chemical M or the composition (C) is brought into contact with the second surface 11b of the resin layer 11 is not particularly limited, but is, for example, preferably 0° C. to 50° C. and more preferably 5° C. to 35° C.

In a case where the chemical M or the composition (C) is brought into contact with the second surface 11b of the resin layer 11 by the above-described method (2) or method (3), it is preferable that after the contact, the second surface 11b of the resin layer 11 and the first surface 11a as necessary are dried. The resin layer 11 is, for example, preferably air-dried at 0° C. to 50° C. and more preferably air-dried at 5° C. to 35° C.

It is preferable to perform a surface treatment on the second surface 11b of the resin layer 11 before the chemical M or the composition (C) is brought into contact with the second surface 11b of the resin layer 11. By performing the surface treatment on the second surface 11b of the resin layer 11, the adhesiveness of the chemical M or the composition (C) is further increased, and as a result, the adhesiveness of the chemical layer 12 to the resin layer 11 is increased. In particular, in a case where the film (F) is bonded to the second surface 11b of the resin layer 11, the adhesiveness of the film (F) to the resin layer 11 is increased.

Examples of the surface treatment include a corona treatment, a plasma treatment, a chromic acid treatment, a flame treatment, a hot air treatment, a surface oxidation treatment such as an ozone and ultraviolet treatment, or a method such as sandblasting. Among these, from the viewpoints of the effect of the surface treatment, productivity, and manufacturing cost, a surface oxidation treatment is preferable and a corona treatment is particularly preferable.

### Method For Using Resin Film

The resin film 10 can be widely used in a portion where the activity of the microorganism is to be reduced. Specifically, the activity of the microorganism can be reduced only by providing the resin film 10 at a portion where the activity of the microorganism is to be reduced (for example, building material applications such as a wall material, a wall paper, a ceiling material, a floor material, a door knob, a door, a hanging strap, a handrail of a building; an interior material of a mobile object such as an automobile, a train, a marine vessel, and an airplane; a building material or a facility in a medical facility; a packaging material for a medical instrument; and the like).

In a case where the resin film 10 is provided at these positions, the resin film 10 is provided such that the first surface 11a of the resin layer 11, that is, the front surface 10a of the resin film 10 is brought into contact with the microorganism.

A method of providing the resin film 10 is not particularly limited, and the resin film 10 may be attached to a predetermined portion using, for example, a pressure-sensitive adhesive or an adhesive. In addition, in a case where the chemical layer 12 has pressure-sensitive adhesiveness, the resin film 10 may be attached to the predetermined portion such that the second surface 12b of the chemical layer 12, that is, the back surface 10b of the resin film 10 is brought into contact with the predetermined portion.

The resin film 10 is also useful for building and building material applications. In a case of being used for a building material application, it is preferable that the resin film has a property of being easily bent, and a bending strength is required such that the resin film does not crack or break even when the resin film is bent.

As the index, a bending strength measured by an ASTM D790 method is used, and the bending strength is preferably 300 kg/cm² or more, more preferably 400 kg/cm² or more, and still more preferably 500 kg/cm² or more. In addition, the bending strength is preferably 2,000 kg/cm² or less, more preferably 1,500 kg/cm² or less, and still more preferably 1,000 kg/cm² or less.

In addition, it is preferable that the resin film has a strength that can withstand scratching from the outside. As the index, a Rockwell hardness measured by an ASTM D785 method is used, and R50 or more is preferable, R75 or more is preferable, and R100 or more is more preferable. In addition, R200 or less is preferable, R150 or less is preferable, and R125 or less is still more preferable.

In a case of pressure-sensitive adhering to be attached to a wall or the like, it is preferable that the glass transition temperature is normal temperature, that is, 0° C. or lower because the softer resin film is easier to handle. The glass transition temperature is more preferably −10° C. or lower and still more preferably −20° C. or lower. In addition, it is preferable that the resin film has a property of being easily adhered to an object to be attached, that is, tackiness, and it is preferable that the resin film has tackiness at −5° C. to 20° C.

### Operating Effects

In the resin film 10 according to the present embodiment, since the chemical M permeates the resin layer 11 and the chemical M is present on the first surface 11a of the resin layer 11, that is, the front surface 10a of the resin film 10, the antimicrobial activity can be exhibited. In addition, since the chemical M permeates the resin layer 11, even in a case where the chemical M present on the first surface 11a of the resin layer 11 is consumed and decreased, at least a part of the chemical M that has permeated the resin layer 11 gradually oozes out to the first surface 11a of the resin layer 11, thereby the antimicrobial activity can be maintained for a long period of time.

Furthermore, since the resin film 10 according to the present embodiment includes the chemical layer 12, at least a part of the chemical M contained in the chemical layer 12 also gradually permeates from the second surface 11b to the first surface 11a of the resin layer 11 and oozes out to the first surface 11a, thereby the antimicrobial activity can be maintained for a longer period of time.

In a case where the concentration of the chemical M reaches equilibrium, the permeation of the chemical M from the inside of the resin layer 11 and the chemical layer 12 to the first surface 11a of the resin layer 11 does not proceed further, thereby it is easy to maintain a state in which a constant amount of the chemical M is always present on the first surface 11a of the resin layer 11.

As described above, in the resin film 10 according to the present embodiment, since the chemical M is oozed from the back surface 10b side to the front surface 10a side, it is easy to adjust the concentration of the chemical M on the front surface 10a of the resin film 10. In particular, since the concentration of the chemical M in the chemical layer 12 can be easily adjusted by adjusting the thickness of the chemical layer 12, the duration of the antimicrobial activity can be easily controlled.

In addition, since the chemical layer 12 is located on the back surface 10b side of the resin film 10, the chemical layer 12 is less likely to be touched by a human hand or the like. Therefore, even in a case where the chemical layer 12 contains the chemical M having a strong stimulus to the skin at a high concentration, the chemical layer 12 is difficult to come into contact with a human hand or the like, thereby the handleability is also excellent.

The amount of the chemical M present on the front surface 10a of the resin film is not particularly limited as long as it is an amount at which the antimicrobial activity can be exhibited. For example, in a case where the chemical M is present to such an extent that the chemical M can be specified in the surface analysis or the pH test of Examples, the resin film can have antimicrobial activity. For example, 1 square centimeter of the surface of the resin film preferably contains 5.5×10⁻¹⁰ mol or more of the chemical M, more preferably contains 1.0×10⁻⁹ mol or more of the chemical M, and still more preferably contains 2.5 to 10⁻⁹ mol or more of the chemical M.

In addition, the pH of the front surface 10a of the resin film 10 is preferably less than 7 due to the chemical M. The pH of the front surface 10a is measured as follows. A pH test paper (pH 1-14 test paper) is cut to a length of 1.5 cm and placed on the front surface 10a of the resin film 10. One drop of water having a pH of 7 is added dropwise onto the pH test paper, and the color change of the pH test paper is visually observed after 5 minutes. The color of the pH test paper is compared with a color chart to obtain a pH measurement value.

### Other Embodiments

The resin film according to the embodiment of the present invention is not limited to the above-described embodiments. For example, a peelable coating layer (not shown) may be provided on the second surface of the chemical layer. In particular, in a case where the chemical layer has pressure-sensitive adhesiveness, it is preferable that the coating layer is provided until immediately before the resin film is used, and the coating layer may be peeled off from the chemical layer immediately before the resin film is used.

Examples of the coating layer include a film obtained by applying a peeling agent to one surface of the base material film and performing a peeling treatment.

Examples of the base material film include polyethylene terephthalate (PET), polyethylene, polypropylene, polystyrene, polyvinyl chloride, an acrylic resin, and the like.

Examples of the peeling agent include a silicone resin.

In addition, the chemical layer may not be provided on the second surface of the resin layer, but from the viewpoint of increasing the duration of the antimicrobial activity, the chemical layer is preferably provided on the second surface of the resin layer.

The resin film not including the chemical layer is obtained, for example, by peeling off the formed chemical layer after the chemical has permeated to the first surface of the resin layer by any of the above-described methods (1) to (3).

In addition, the resin film may be produced by bringing the chemical or the composition (C) into contact with the first surface of the resin layer to allow the chemical to permeate to the second surface of the resin layer. Provided that from the viewpoint of being able to suppress stickiness of the front surface of the resin film caused by the chemical, the chemical preferably permeates from the second surface to the first surface of the resin layer. In a case where the chemical is brought into contact with the first surface of the resin layer by bonding the film (F) to the first surface of the resin layer, the film (F) is peeled off from the resin layer after the chemical has permeated the resin layer and preferably after the chemical has permeated to the second surface of the resin layer.

Furthermore, the resin film may be produced by bringing the chemical or the composition (C) into contact with the first surface of the resin layer by immersing the first surface of the resin layer in the chemical or the composition (C), and allowing the chemical to permeate the resin layer. In addition, the resin film may be produced by bringing the chemical or the composition (C) into contact with the first surface and the second surface of the resin layer by immersing the entire resin layer in the chemical or the composition (C), and allowing the chemical to permeate the resin layer. In a case where the chemical layer is formed on the first surface of the resin layer, the chemical layer is peeled off.

### Method for Imparting Antimicrobial Activity

The method for imparting antimicrobial activity according to the second aspect of the present invention is a method of bringing a chemical or a composition (C) containing the chemical into contact with the second surface of the resin layer having chemical permeability to allow at least a part of the chemical to permeate to the first surface of the resin layer, thereby imparting antimicrobial activity to the first surface of the resin layer.

Examples of the resin layer to which the antimicrobial activity is to be imparted include the resin layers exemplified above in the description of the resin film according to the first aspect of the present invention. In addition, the resin layer may be a product (for example, a curtain, a sponge, or the like) made of, for example, polyamide, cellulose resin, polyurethane, or the like.

Examples of the chemical and the composition (C) include the chemical and the composition (C) each described above in the description of the resin film according to the first aspect of the present invention.

Examples of a method of bringing the chemical or the composition (C) into contact with the second surface of the resin layer include the methods (1) to (3) exemplified above in the description of the resin film according to the first aspect of the present invention.

A contact time in a case where the chemical or the composition (C) is brought into contact with the second surface of the resin layer is preferably 5 seconds or more, more preferably 10 seconds or more, still more preferably 1 minute or more, and particularly preferably 5 minutes or more. The contact time may be 20 minutes or more, but usually, a sufficient antimicrobial activity is obtained by a contact for 20 minutes.

A contact temperature in a case where the chemical or the composition (C) is brought into contact with the second surface of the resin layer is not particularly limited, but is, for example, preferably 0° C. to 50° C. and more preferably 5° C. to 35° C.

In a case where the chemical or the composition (C) is brought into contact with the second surface of the resin layer by the above-described method (2) or method (3), it is preferable that after the contact, the second surface of the resin layer and the first surface as necessary are dried. The resin layer is, for example, preferably air-dried at 0° C. to 50° C. and more preferably air-dried at 5° C. to 35° C.

It is preferable to perform a corona treatment on the second surface of the resin layer before the chemical or the composition (C) is brought into contact with the second surface of the resin layer.

The antimicrobial activity is imparted to the first surface of the resin layer by bringing the chemical or the composition (C) into contact with the first surface of the resin layer to allow the chemical to permeate to the second surface of the resin layer. In addition, the antimicrobial activity is imparted to the first surface of the resin layer by bringing the chemical or the composition (C) into contact with at least the first surface of the resin layer by immersing the first surface of the resin layer or the entire resin layer in the chemical or the composition (C), and allowing the chemical to permeate the resin layer. In a case where the chemical layer is formed on the first surface of the resin layer, the chemical layer is peeled off.

### EXAMPLES

A description will be given below of the present invention using Examples, but the present invention is not limited thereto. Embodiments of the present invention can be variously modified within the range not changing the gist of the present invention.

### Example 1

As the resin layer, a nylon 6 film [manufactured by Mitsubishi Chemical Corporation, trade name “DIAMIRON (registered trademark) C”, 50 mm×70 mm×thickness of 100 μm, single-layer film, water absorption rate of 1.6% (measured by ASTM D570 method)] which had been subjected to a corona treatment on one surface, was used.

As a film (F) which was the chemical layer, an acrylic double-sided pressure-sensitive adhesive film (thickness of 150 μm) was used.

The acrylic double-sided pressure-sensitive adhesive film was prepared by mixing 90 g of pentaerythritol tetraacrylate, 15 g of 2,4,6-trimethylbenzophenone, and 10 g of γ-methacryloxypropyltrimethoxysilane with 1 Kg of a copolymer which has been obtained by mixing 4 parts by weight of acrylic acid, 10 parts by weight of vinyl acetate, and 70 parts by weight of 2-ethylhexyl acrylate to prepare a pressure-sensitive adhesive composition, forming the pressure-sensitive adhesive composition on a polyethylene terephthalate film to have a thickness of 150 μm, and coating with the polyethylene terephthalate film as a light separator (peelable layer).

The light separator (peelable layer) was peeled off from the pressure-sensitive adhesive film, and the pressure-sensitive adhesive film was attached to the corona-treated surface of the nylon 6 film to obtain a test piece.

A surface of the nylon 6 film, on which the corona treatment has been performed, is a second surface (back surface) of the resin layer, and a surface of the nylon 6 film, on which the corona treatment has not been performed, is a first surface (front surface) of the resin layer. In addition, in the test piece, the surface of the nylon 6 film side, that is, the first surface of the resin layer is the front surface of the test piece, and the surface of the pressure-sensitive adhesive film side is the back surface of the test piece.

### Example 2

The test piece obtained in the same manner as in Example 1 was stored indoors for 11 months.

### Example 3

A biaxially stretched single-layer film was produced by biaxially stretching the nylon 6 film similar to the nylon 6 film in Example 1 to a thickness of 25 μm. The light separator (peelable layer) was peeled off from the acrylic double-sided pressure-sensitive adhesive film in the same manner as in Example 1, and the pressure-sensitive adhesive film was attached to the biaxially stretched single-layer film to obtain a test piece.

### Example 4

A low-melting-point nylon film having a thickness of 125 μm was prepared. The light separator (peelable layer) was peeled off from the acrylic double-sided pressure-sensitive adhesive film in the same manner as in Example 1, and the pressure-sensitive adhesive film was attached to the low-melting-point nylon film to obtain a test piece.

### Comparative Example 1

A film made of nylon 6 [manufactured by Mitsubishi Chemical Corporation., trade name “DIAMIRON (registered trademark) C”, 50 mm×70 mm×thickness of 100 μm, single-layer film] which had been subjected to a corona treatment on one surface, was used as a comparative test piece.

A surface of the nylon 6 film, on which the corona treatment has been performed, is a second surface (back surface) of the resin layer, and a surface of the nylon 6 film, on which the corona treatment has not been performed, is a first surface (front surface) of the resin layer. In addition, a first surface of the resin layer is a front surface of the comparative test piece, and a second surface of the resin layer is a back surface of the comparative test piece.

### Surface Analysis

(Surface analysis by time-of-flight secondary ion mass spectrometry (TOF-SIMS))

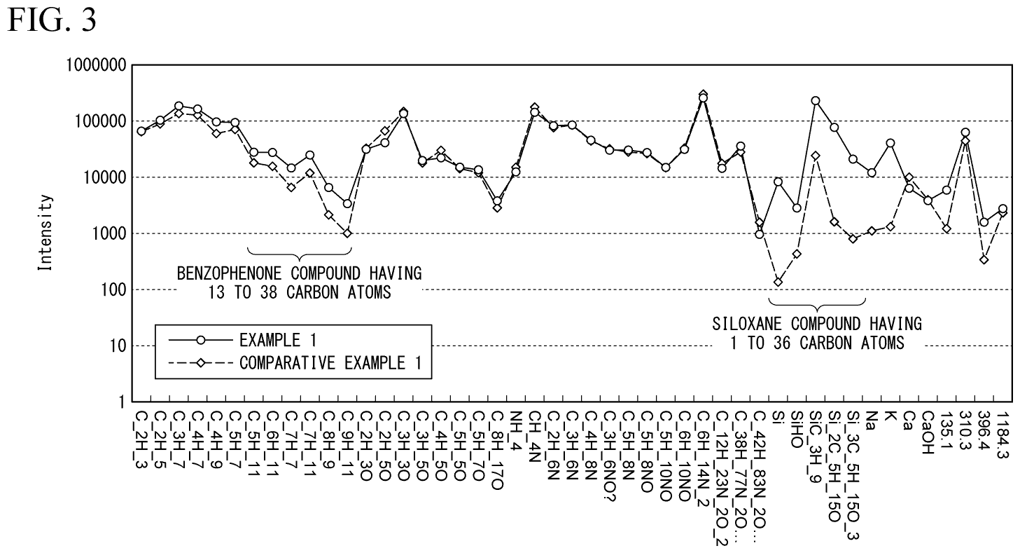

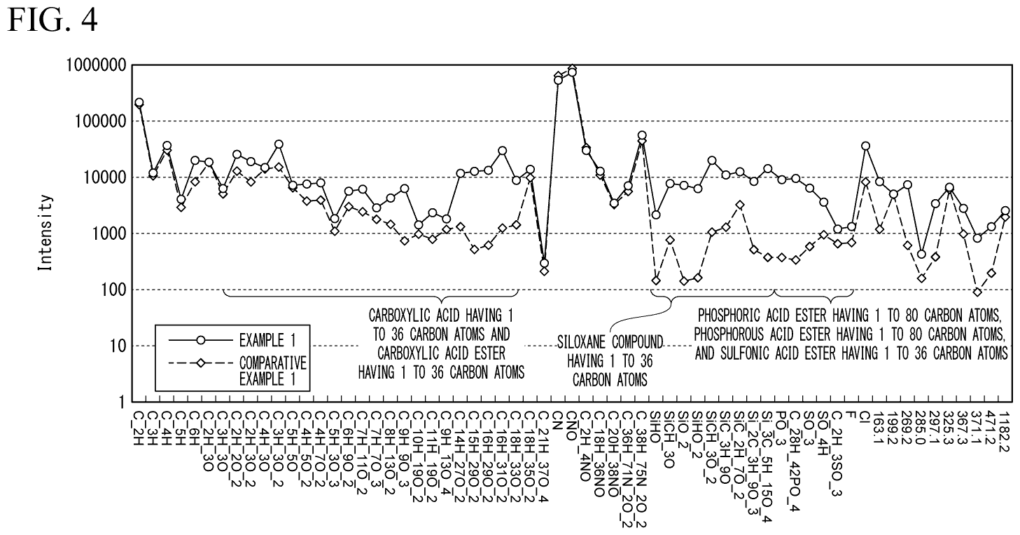

A time-of-flight secondary ion mass spectrometry device (manufactured by ION-TOF GmbH, product name “TOF-SIMSIV”) was used to perform surface analysis of the front surface of the test piece and the comparative test piece, that is, the first surface of the resin layer, under the following conditions. FIGS. 3 and 4 show the main ion strength.

### (TOF-SIMS Measurement Conditions)

Qualitative analysis: microspectral measurement
Primary ion: Bi₃²⁺
Acceleration voltage: 25 kV
Measurement range: 200 μm square
Measurement mode: positive and negative ion detection
Number of times of integration: 30 times
Charge correction: using Flood Gun

From the results of FIGS. 3 and 4, it was shown that the chemical derived from the carboxylic acid having 1 to 36 carbon atoms, the carboxylic acid ester having 2 to 36 carbon atoms, the sulfonic acid ester having 1 to 36 carbon atoms, the siloxane compound having 1 to 36 carbon atoms, the benzophenone compound having 13 to 38 carbon atoms, and the phosphoric acid ester having 1 to 80 carbon atoms was present on the surface of the test piece obtained in Example 1, that is, the first surface of the resin layer.

From these results, in the case of Example 1, it was found that the chemical contained in the pressure-sensitive adhesive film permeated from the second surface to the first surface of the resin layer and oozed out to the first surface.

### Surface Analysis by pH Measurement

A pH test paper (PH 1-14 test paper) was cut to a length of 1.5 cm and disposed on the front surface of the test piece and the comparative test piece, that is, the first surface of the resin layer. One drop of water having a pH of 7 was added dropwise onto the pH test paper, and the color change of the pH test paper was visually observed after 5 minutes.

As a result, the pH test paper disposed on the front surface of the test piece obtained in Example 1 showed a slightly bright orange color, and the pH was 6.

On the other hand, the pH test paper disposed on the front surface of the comparative test piece obtained in Comparative Example 1 showed a green color, and the pH was 7.

From these results, it was found that the front surface of the test piece obtained in Example 1 contained an acidic component.

### Antibacterial Test

An antibacterial test was performed in accordance with JIS Z 2801:2012.

As a test bacterium, Staphylococcus aureus and Escherichia coli, which were shown below, were used.
Staphylococcus aureus: Staphylococcus aureus (ATCC12732)
Escherichia coli: Escherichia coli (ATCC3972)

The test bacterium was transplanted to a nutrient agar medium and cultured at 35° C. for 24 hours. 3 to 5 colonies of the bacteria generated by the culture were uniformly dispersed in 2 mL of a nutrient broth medium at a 1/500 concentration, and 100 μL thereof was uniformly dispersed in 10 mL of a nutrient broth medium at a 1/500 concentration to prepare a test bacterial solution.

300 μL of the test bacterial solution was added dropwise onto the front surface of the test piece, that is, the first surface of the resin layer, and an acrylic film (40 mm×40 mm) was placed thereon and pressed such that the test bacterial solution was spread over the entire surface.

The test pieces were allowed to stand at a temperature of 35° C. and a relative humidity of 90% or higher for 24 hours. Test pieces after standing for 24 hours were placed in a sterile stomacher bag, 10 mL of SCDLP broth medium was added thereto, and the bacterial solution was thoroughly washed out to prepare a specimen. 1 mL of the specimen was cultured at 35° C. for 48 hours using a standard agar medium, and then the number of viable bacteria was measured to evaluate the antibacterial property based on the number of viable bacteria in the washing liquid.

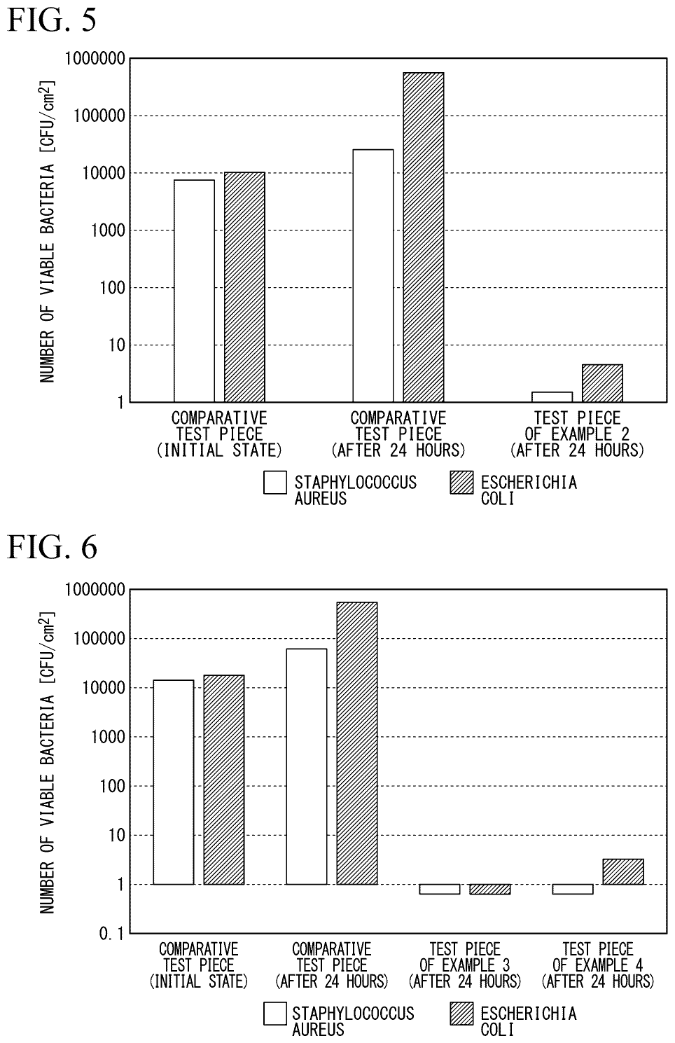

Note that three test pieces were prepared, and an antibacterial test was performed on all the test pieces to obtain an average value of the number of viable bacteria. The results are shown in FIGS. 5 and 6. The vertical axis in FIGS. 5 and 6 is a common logarithmic scale.

300 μL of the test bacterial solution was separately added dropwise onto the front surface of the comparative test piece, that is, the first surface of the resin layer, and a polyethylene terephthalate plate (40 mm×40 mm) was placed thereon and pressed such that the test bacterial solution was spread over the entire surface.

In one of the comparative test pieces, the number of viable bacteria was measured immediately after that (comparative test piece (initial stage)).

Another one of the comparative test pieces was allowed to stand at a temperature of 35° C. and a relative humidity of 95% for 24 hours. The comparative test pieces after standing for 24 hours were placed in a sterile stomacher bag, 10 mL of SCDLP broth medium was added thereto, and the bacterial solution was thoroughly washed out to prepare a specimen. 1 mL of the specimen was cultured at 35° C. for 48 hours using a standard agar medium, and then the number of viable bacteria was measured to evaluate the antibacterial property based on the number of viable bacteria in the washing liquid (comparative test piece (after 24 hours)).

Six comparative test pieces were prepared, divided into two groups of three pieces each, and an antibacterial test was performed on all the comparative test pieces to obtain an average value of the number of viable bacteria. The results are shown in FIGS. 5 and 6.

From the results shown in FIG. 5, it was found that the comparative test piece obtained in Comparative Example 1 did not have the antibacterial property, but the test piece obtained in Example 2 had a high antibacterial property.

From the results shown in FIG. 6, it was found that the comparative test piece obtained in Comparative Example 1 did not have the antibacterial property, but the test pieces obtained in Example 3 or Example 4 had a high antibacterial property.

### Antiviral Test 1

An antiviral test was performed in accordance with ISO 21702:2019.

As a test virus, an A-type influenza virus (H1N1) A/PR/8/34 ATCC VR-1469 was used.

The supernatant obtained by centrifuging the virus culture solution after the cell culture was diluted 10 times with purified water to prepare a virus solution.

The test piece and the comparative test piece were cut into 3 cm×3 cm, immersed in 70% by volume ethanol water, and then dried in the air. 0.1 mL of the virus solution was added dropwise onto the front surface of the test piece and the comparative test piece, that is, the first surface of the resin layer, and stored at room temperature (20° C.) for a predetermined time.

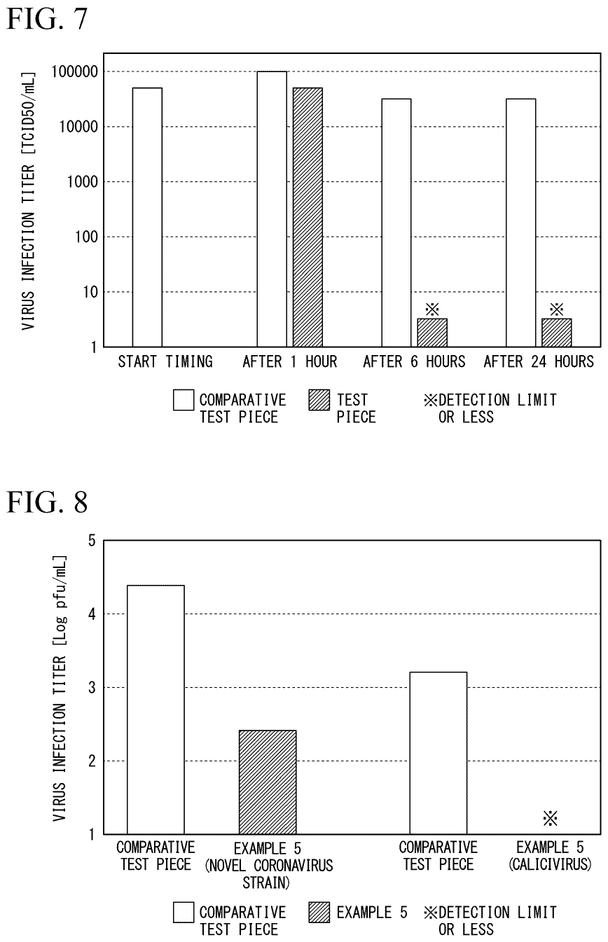

One hour, 6 hours, and 24 hours after the start of the storage, each of the test piece and the comparative test piece was washed with 2 mL of a cell maintenance medium, and the infection titer was measured by a TCID50 method. FIG. 7 shows the results. The vertical axis in FIG. 7 is a common logarithmic scale.

From the results shown in FIG. 7, it was found that the comparative test piece obtained in Comparative Example 1 did not have antiviral properties, but the test piece obtained in Example 1 had high antiviral properties.

### Antiviral Test 2

A novel coronavirus delta strain virus solution having the same envelope type as the A type influenza virus and a calicivirus solution having a non-envelope type were each diluted 10 times with sterile Milli-Q water. 150 μL of the diluted virus solution was dropped onto the test piece, and covered with a 25 mm square acrylic film. The covered test piece was allowed to stand at 25° C. in a wet state for 24 hours. The virus solutions were each collected in 1.35 mL of a culture medium, and the infection titer was measured by a plaque method. FIG. 8 shows the results.

From the results shown in FIG. 8, it was found that the comparative test piece obtained in Comparative Example 1 did not have antiviral properties, but the test piece obtained in Example 5 had high antiviral properties against the novel coronavirus delta strain virus and the feline calicivirus.

### INDUSTRIAL APPLICABILITY

Since the resin film according to the embodiment of the present invention has excellent antimicrobial activity, in a case of being used as a film for food packaging, it is possible to suppress the deterioration of the food by the microorganism for a long period of time. Therefore, the amount of food to be discarded is reduced, and the food waste can be significantly reduced. In addition, since the resin film according to the embodiment of the present invention has antibacterial property and antiviral property, the resin film according to the embodiment of the present invention is also useful as a building material for a hospital, a school, or the like.

### REFERENCE SIGNS LIST

10: Resin film
10a: Front surface
10b: Back surface
11: Resin layer
11a: First surface
11b: Second surface
12: Chemical layer
12a: First surface
12b: Second surface

1. A resin film comprising:
a resin layer having chemical permeability; and
a chemical layer,
wherein the resin layer is hydrophilic,
at least one chemical selected from the group consisting of a carboxylic acid having 1 to 36 carbon atoms, a carboxylic acid ester having 2 to 36 carbon atoms, a sulfonic acid ester having 1 to 36 carbon atoms, a siloxane compound having 1 to 36 carbon atoms, a benzophenone compound having 13 to 38 carbon atoms, a phosphoric acid ester having 1 to 80 carbon atoms, and a phosphorous acid ester having 1 to 80 carbon atoms permeates the resin layer and the chemical is present on a first surface of the resin layer, and
the chemical layer containing the chemical is provided on a second surface of the resin layer.

2. The resin film according to claim 1,
wherein the chemical is at least one selected from the group consisting of a carboxylic acid having 1 to 30 carbon atoms, a carboxylic acid ester having 2 to 30 carbon atoms, a sulfonic acid ester having 1 to 18 carbon atoms, a siloxane compound having 1 to 18 carbon atoms, a benzophenone compound having 13 to 20 carbon atoms, a phosphoric acid ester having 1 to 40 carbon atoms, and a phosphorous acid ester having 1 to 40 carbon atoms.

3. (canceled)

4. The resin film according to claim 1,
wherein the resin layer contains at least one resin selected from the group consisting of polyamide, a cellulose resin, and polyurethane.

5. The resin film according to claim 4,
wherein the resin layer contains polyamide, and the polyamide includes either or both of nylon 6 and nylon 66.

6. The resin film according to claim 1,
wherein the resin layer has a film thickness of 20 μm or more.

7. A building material comprising the resin film according to claim 1.

8. A method for producing a resin film which is a method for producing the resin film according to claim 1, the method comprising:
bringing the chemical or a composition containing the chemical into contact with the second surface of the resin layer for 5 seconds or more and allowing at least a part of the chemical to permeate to the first surface of the resin layer, to impart antimicrobial activity to the first surface of the resin layer.

9. A method for using a resin film which is a method for using the resin film according to claim 1, the method comprising:
providing the resin film at a portion where activity of a microorganism is to be reduced, such that the first surface of the resin layer is brought into contact with the microorganism.

10. A method for imparting antimicrobial activity, comprising:
bringing a chemical that is at least one selected from the group consisting of a carboxylic acid having 1 to 36 carbon atoms, a carboxylic acid ester having 2 to 36 carbon atoms, a sulfonic acid ester having 1 to 36 carbon atoms, a siloxane compound having 1 to 36 carbon atoms, a benzophenone compound having 13 to 38 carbon atoms, and a phosphoric acid ester having 1 to 80 carbon atoms, or a composition containing the chemical, into contact with a second surface of a resin film having hydrophilic and chemical permeability, and allowing at least a part of the chemical to permeate to a first surface of a resin layer, to impart antimicrobial activity to the first surface of the resin layer.
